(19) United States
(12) Patent Application Publication
(10) Pub. No.: US 2020/0111138 A1
(43) Pub. Date: Apr. 9, 2020

(54) HYDROGEN SUPPLY AND DEMAND MATCHING SYSTEM, HYDROGEN SUPPLY AND DEMAND MATCHING METHOD

(71) Applicant: TOYOTA JIDOSHA KABUSHIKI KAISHA, Toyota-shi (JP)

(72) Inventors: Tetsu TODO, Aichi-gun (JP); Koichi IKEMOTO, Nagoya-shi (JP); Motoki HAMAZAKI, Toyota-shi (JP); Katsuhiko HIROSE, Toyota-shi (JP); Atsushi MIZUTANI, Toyota-shi (JP); Shuntaro KATO, Nagoya-shi (JP); Yohei TANIGAWA, Toyota-shi (JP)

(21) Appl. No.: 16/561,138

(22) Filed: Sep. 5, 2019

(30) Foreign Application Priority Data
Oct. 5, 2018 (JP) 2018-189990

(51) Int. Cl. G06Q 30/06

(52) U.S. Cl. CPC G06Q 30/0605

(57) ABSTRACT

A hydrogen supply and demand matching system comprises a plurality of hydrogen utilizing districts each including a hydrogen utilizing facility, and a management system configured to manage an amount of hydrogen in each of the plurality of hydrogen utilizing districts. The management system (a) estimates a state of supply and demand of hydrogen in each of the plurality of hydrogen utilizing districts, and (b) proposes exchange of hydrogen among the plurality of hydrogen utilizing districts in accordance with the state of supply and demand in each of the plurality of hydrogen utilizing districts.

### CROSS REFERENCE TO RELATED APPLICATIONS

The present application claims priority to Japanese Patent Application No. 2018-189990, filed on Oct. 5, 2018, the contents of which are incorporated herein by reference in their entirety.

### BACKGROUND

### Field

The present disclosure relates to a hydrogen supply and demand matching system configured to obtain matching of states of supply and demand of hydrogen among a plurality of districts.

### Related Art

JP 2004-288422A discloses a system configured to utilize a fuel gas manufacturing apparatus to sell own-made gas containing hydrogen gas.

A state of supply and demand of hydrogen greatly differs per district. It is preferable that matching of states of supply and demand of hydrogen among a plurality of districts be obtained. Such technology has not yet been fully improved that obtains matching of states of supply and demand of hydrogen among a plurality of districts.

### SUMMARY

(1) According to an aspect of the present disclosure, a hydrogen supply and demand matching system is provided. The hydrogen supply and demand matching system comprises a plurality of hydrogen utilizing districts and a management system. The plurality of hydrogen utilizing districts each include a hydrogen utilizing facility. The management system is configured to manage an amount of hydrogen in each of the plurality of hydrogen utilizing districts. The management system (a) estimates a state of supply and demand of hydrogen in each of the plurality of hydrogen utilizing districts, and (b) proposes exchange of hydrogen among the plurality of hydrogen utilizing districts in accordance with the state of supply and demand in each of the plurality of hydrogen utilizing districts.

The hydrogen supply and demand matching system proposes exchange of hydrogen in accordance with a state of supply and demand of hydrogen in each of the plurality of hydrogen utilizing districts. Matching of supply and demand of hydrogen in the plurality of hydrogen utilizing districts can therefore be obtained.

(2) In the hydrogen supply and demand matching system, the management system may (b1) select two or more hydrogen utilizing districts appropriate for exchange of hydrogen from among the plurality of hydrogen utilizing districts in accordance with the state of supply and demand in each of the plurality of hydrogen utilizing districts, and (b2) send hydrogen matching information proposing exchange of hydrogen between the two or more hydrogen utilizing districts to two or more management devices respectively configured to manage the two or more hydrogen utilizing districts.

The hydrogen supply and demand matching system can therefore obtain matching of supply and demand of hydrogen appropriate for exchange of hydrogen between two or more hydrogen utilizing districts.

The present disclosure can be implemented in various aspects, such as an aspect of a hydrogen supply and demand matching system, an aspect of a management device for the hydrogen supply and demand matching system, and an aspect of a method for managing the hydrogen supply and demand matching system.

### BRIEF DESCRIPTION OF THE DRAWINGS

FIG. 1 is an explanatory diagram illustrating a configuration of a hydrogen supply and demand matching system according to an embodiment.

FIG. 2 is a functional block diagram illustrating a function of a central management system.

FIG. 3 is an explanatory diagram illustrating an example of supply and demand of hydrogen during daytime on a weekday.

FIG. 4 is an explanatory diagram illustrating an example of supply and demand of hydrogen during nighttime on a holiday.

FIG. 5 is an explanatory diagram illustrating exchange of information between the central management system and district management devices.

FIG. 6 is a flowchart illustrating an order of hydrogen supply and demand matching processing.

FIG. 7 is an explanatory diagram illustrating an example of a window displaying district's hydrogen management information.

FIG. 8 is an explanatory diagram illustrating an example of a window displaying hydrogen matching information.

### DETAILED DESCRIPTION

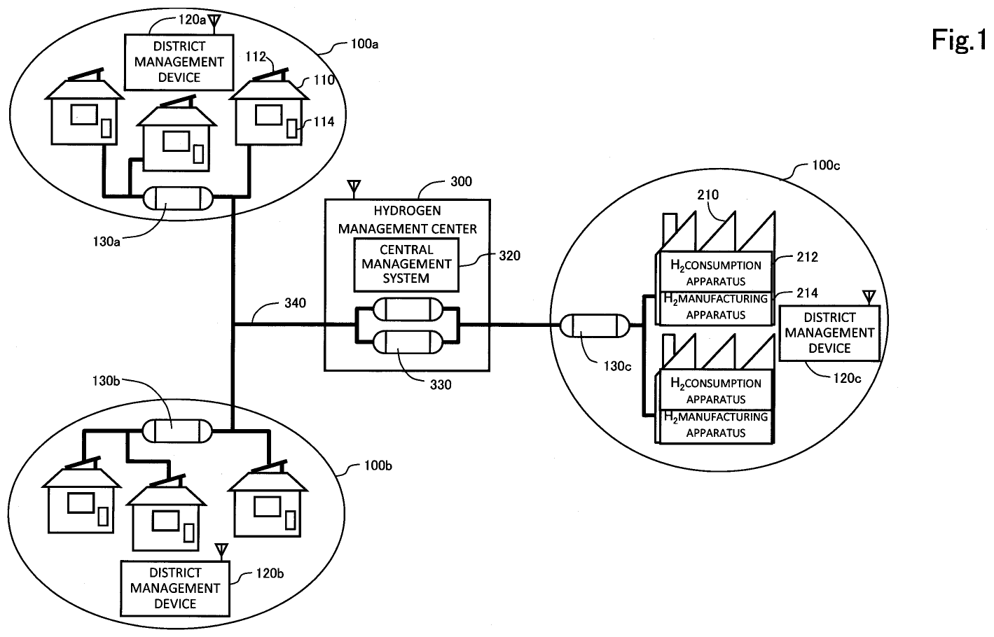

FIG. 1 is an explanatory diagram illustrating a configuration of a hydrogen supply and demand matching system according to an embodiment. The hydrogen supply and demand matching system includes a plurality of hydrogen utilizing districts 100a to 100c, and a hydrogen management center 300. The three hydrogen utilizing districts 100a to 100c include two residential districts, i.e., the districts 100a and 100b, and one industrial district, i.e., the district 100c. Letters “a” to “c” respectively added at ends of reference signs of the three hydrogen utilizing districts 100a to 100c are used to distinguish the three hydrogen utilizing districts 100a to 100c from each other. When the three hydrogen utilizing districts 100a to 100c do not need to be distinguished from each other, the three hydrogen utilizing districts 100a to 100c will be each simply referred to as a “hydrogen utilizing district 100”. This also applies to reference signs of apparatuses used in each of the hydrogen utilizing districts 100.

The first residential district 100a includes a plurality of houses 110, a district management device 120a, and a hydrogen tank 130a. Among the plurality of houses 110, at least one of the houses 110 includes a solar panel 112. The solar panel 112 includes a power generation unit and a hydrogen generation unit. The power generation unit is configured to utilize solar light to generate electric power. The hydrogen generation unit is configured to utilize the electric power generated by the power generation unit to generate hydrogen through electrolysis of water. The electric power generated by the solar panel 112 can be consumed by electrical devices installed in the one of the houses 110. The electric power can otherwise be sold externally. The hydrogen generated by the solar panel 112 can be consumed by a hydrogen utilizing facility 114 installed in the one of the house 110. The hydrogen can otherwise be stored in the hydrogen tank 130a in the residential district 100a. Examples available as the hydrogen utilizing facility 114 include kitchen devices configured to utilize hydrogen gas, hydrogen suction devices used by a person to suck hydrogen gas, and hydrogen water utilizing devices configured to utilize hydrogen water. Typical examples of the kitchen devices configured to utilize hydrogen include hydrogen grills configured to utilize hydrogen gas for cooking and refrigerators configured to supply hydrogen gas to a vegetable compartment to keep vegetables fresh. The district management device 120a is configured to manage an amount of hydrogen in the residential district 100a. The district management device 120a is, for example, a computer possessed by an administrative organization or a residents' association managing the residential district 100a. What the district management device 120a manages will be described later.

Similar to the first residential district 100a, the second residential district 100b includes a plurality of houses 110, a district management device 120b, and a hydrogen tank 130b. The second residential district 100b is similar in configuration to the first residential district 100a, and will not be described in here to omit redundant description.

The industrial district 100c includes a plurality of factories 210, a district management device 120c, and a hydrogen tank 130c. The factories 210 each include a hydrogen consumption apparatus 212 and a hydrogen manufacturing apparatus 214. Examples of the factories 210 include iron mills and chemical plants. Hydrogen manufactured by the hydrogen manufacturing apparatus 214 in one of the factories 210 will be consumed by the hydrogen consumption apparatus 212 in the one of the factories 210. When the one of the factories 210 does not fully consume the hydrogen, the excess hydrogen is stored in the hydrogen tank 130c.

The hydrogen management center 300 has a function of obtaining matching of supply and demand of hydrogen among the plurality of hydrogen utilizing districts 100. The hydrogen management center 300 includes a central management system 320 and a hydrogen buffer 330. The central management system 320 is configured to perform communications with the district management devices 120 in the hydrogen utilizing districts 100 for hydrogen management. In the example of FIG. 1, the central management system 320 is configured to perform wireless communications with the district management devices 120. Wired communications may however constitute some or all of communications. The hydrogen buffer 330 is a buffer configured to temporarily store hydrogen to obtain matching of supply and demand of hydrogen among the plurality of hydrogen utilizing districts 100.

Pipelines 340 couple with each other the hydrogen buffer 330, the hydrogen tanks 130 in the plurality of hydrogen utilizing districts 100, the plurality of houses 110, and the plurality of factories 210. Some or all of the hydrogen tanks 130 may however be eliminated.

Various forms of hydrogen are allowed to pass through the pipelines 340, such as hydrogen gas, liquid hydrogen, and methane and methylcyclohexane (MCH) generated from hydrogen gas. The gases and liquids all serve as fuels containing hydrogen, and are collectively referred to as “hydrogen-containing fuels”. In the specification, a term “hydrogen” denotes hydrogen-containing fuel as well. The pipelines 340 can often be implemented as pipe conduits configured to distribute a hydrogen-containing fuel. In a case where methane is used as a hydrogen-containing fuel, piping for city gas can be utilized as the pipelines 340. In this case, the pipelines 340 can be easily constructed. Although not illustrated, the pipelines 340 may be provided as required with various instruments including valves, pumps, compressors, accumulators, converters for hydrogen-containing fuel, pressure gauges, thermometers, and flowmeters.

In the example of FIG. 1, the central management system 320 and the district management devices 120 work together for hydrogen management. The central management system 320 and the district management devices 120 may however be integrated into a single management system for hydrogen management.

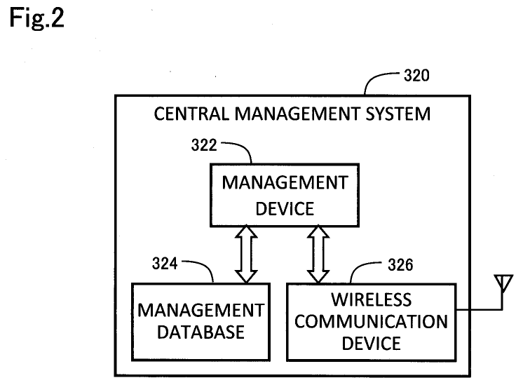

FIG. 2 is a functional block diagram illustrating a function of the central management system 320. The central management system 320 includes a management device 322, a management database 324, and a wireless communication device 326. The management device 322 is achieved by a computer including a processor and a memory, for example. The management database 324 is a database configured to be registered with a history of supply and demand of hydrogen in the plurality of hydrogen utilizing districts 100. The wireless communication device 326 is configured to perform wireless communications with the district management devices 120 in the plurality of hydrogen utilizing districts 100 to send and receive various kinds of information.

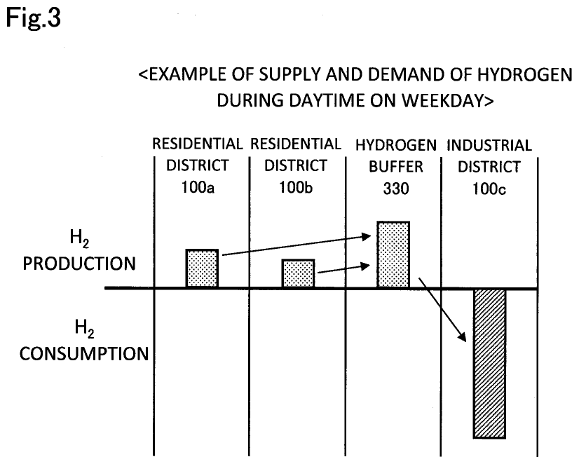

FIG. 3 is an explanatory diagram illustrating an example of supply and demand of hydrogen during daytime on a weekday. Bar graphs in FIG. 3 each illustrate a net amount of hydrogen. An amount of production of hydrogen in each district is illustrated to have a positive value. An amount of consumption of hydrogen in each district is illustrated to have a negative value. In the example, in a time slot during daytime on a weekday, amounts of production of hydrogen respectively exceed amounts of consumption of hydrogen in the residential districts 100a and 100b. An amount of consumption of hydrogen, on the other hand, exceeds an amount of production of hydrogen in the industrial district 100c. In this case, hydrogen produced in the residential districts 100a and 100b is temporarily stored in the hydrogen buffer 330. The hydrogen may be supplied from the hydrogen buffer 330 to the industrial district 100c in accordance with a request from the industrial district 100c. Supply and demand among the three districts 100a to 100c can thus be balanced.

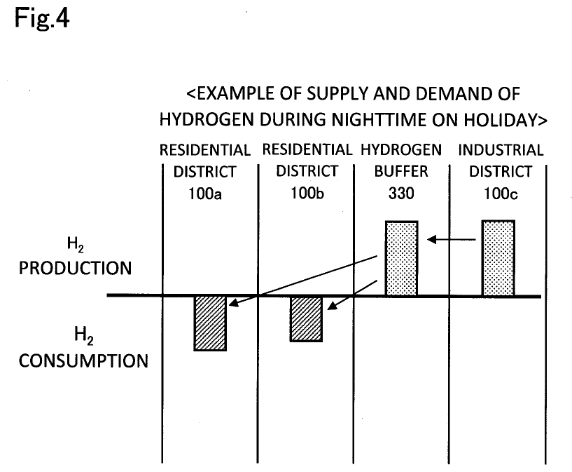

FIG. 4 is an explanatory diagram illustrating an example of supply and demand of hydrogen during nighttime on a holiday. In the example, in a time slot during nighttime on a holiday, amounts of consumption of hydrogen respectively exceed amounts of production of hydrogen in the residential districts 100a and 100b. An amount of production of hydrogen, on the other hand, exceeds an amount of consumption of hydrogen in the industrial district 100c. In this case, hydrogen produced in the industrial district 100c is temporarily stored in the hydrogen buffer 330. The hydrogen may be supplied from the hydrogen buffer 330 to the residential districts 100a and 100b in accordance with requests from the residential districts 100a and 100b. Supply and demand among the three districts 100a to 100c can thus be balanced.

In the examples in FIGS. 3 and 4, excess hydrogen is temporarily stored in the hydrogen buffer 330. The hydrogen buffer 330 may however be eliminated. Hydrogen may directly be exchanged among the plurality of districts 100.

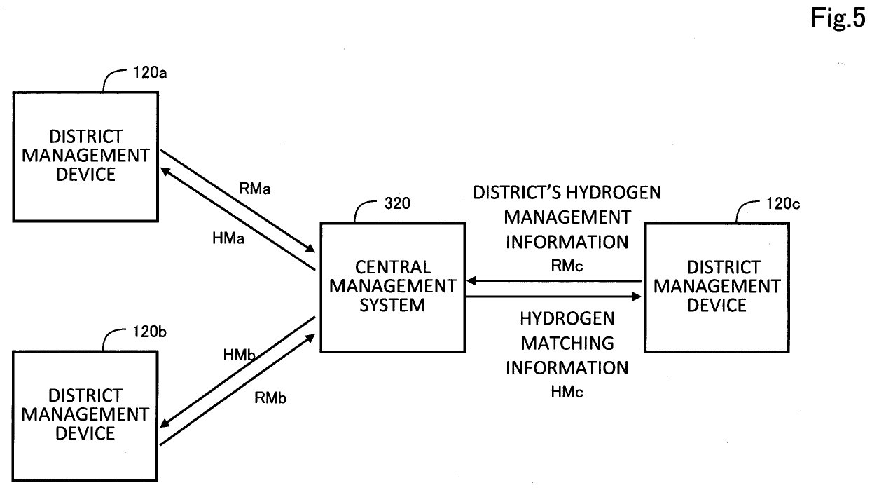

FIG. 5 is an explanatory diagram illustrating exchange of information between the central management system 320 and the district management devices 120a to 120c. To obtain matching of supply and demand of hydrogen among the three hydrogen utilizing districts 100a to 100c, the central management system 320 receives pieces of district's hydrogen management information RMa to RMc respectively from the district management devices 120a to 120c. The central management system 320 sends pieces of hydrogen matching information HMa to HMc respectively to the district management devices 120a to 120c. When the three pieces of district's hydrogen management information RMa to RMc do not need to be distinguished from each other, the three pieces of district's hydrogen management information RMa to RMc will be herein collectively referred to as “district's hydrogen management information RM”. Similarly, when the three pieces of hydrogen matching information HMa to HMc do not need to be distinguished from each other, the three pieces of hydrogen matching information HMa to HMc will be herein collectively referred to as “hydrogen matching information HM”.

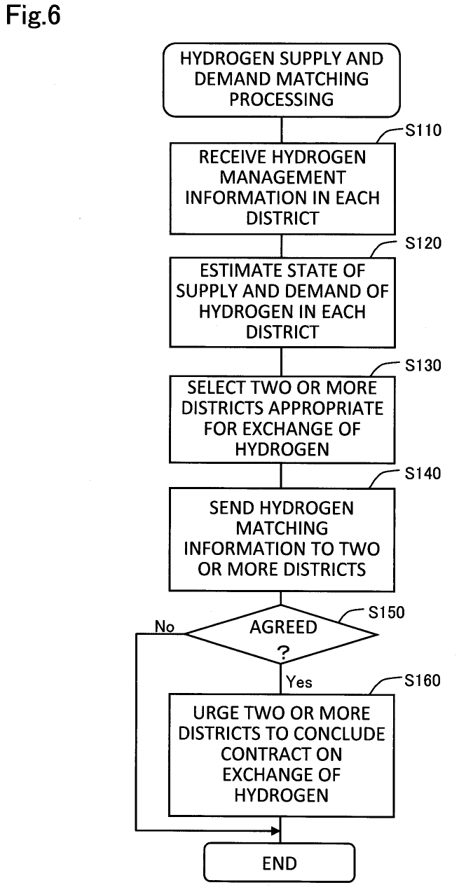

FIG. 6 is a flowchart illustrating an order of hydrogen supply and demand matching processing to be executed by the central management system 320. In step S110, the district's hydrogen management information RM is received from the district management device 120 in each of the districts 100.

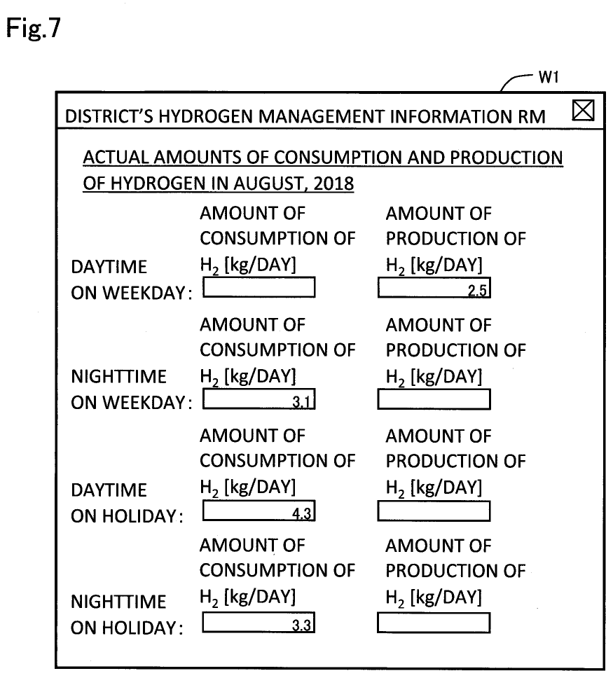

FIG. 7 is an explanatory diagram illustrating an example of a window W1 displaying the district's hydrogen management information RM. In the example, the district's hydrogen management information RM contains an amount of consumption of hydrogen and an amount of production of hydrogen within a certain month in one of the hydrogen utilizing districts 100. Amounts of consumption of hydrogen and amounts of production of hydrogen are each calculated per four time slots of (a) during daytime on a weekday, (b) during nighttime on a weekday, (c) during daytime on a holiday, and (d) during nighttime on a holiday. As illustrated in the example, when the district's hydrogen management information RM is configured to contain actual values of amounts of consumption of hydrogen and amounts of production of hydrogen per plurality of time slots, the district's hydrogen management information RM can be used to easily know a situation of supply and demand of hydrogen in one of the districts 100. It is preferable that the window W1 be displayed on a screen of each of the district management devices 120 and a screen of the central management system 320.

The district's hydrogen management information RM may be configured to contain, in addition to the information illustrated in FIG. 7, at least one of various kinds of information described below.

(1) Seasonal changes in amount of production of hydrogen and in amount of consumption of hydrogen

(2) Weather forecast in each of the districts 100, including sunshine hours and air temperature

(3) Plan of operation in each of the factories 210

In step S120 in FIG. 6, the central management system 320 uses the district's hydrogen management information RM received from one of the districts 100 to estimate a state of supply and demand of hydrogen in the one of the districts 100. A state of supply and demand of hydrogen in each of the districts 100 represents, for example, a quantified amount of hydrogen that needs to be transferred from another one of the districts 100 or a quantified amount of hydrogen that is transferrable to other ones of the districts 100. It is preferable that a state of supply and demand of hydrogen be estimated per a plurality of time slots or a plurality of periods of time, for example.

In step S130 in FIG. 6, the central management system 320 uses the estimated state of supply and demand of hydrogen to select two or more districts appropriate for exchange of hydrogen from among the districts 100. In step S140, the hydrogen matching information HM is sent to the two or more of the districts 100.

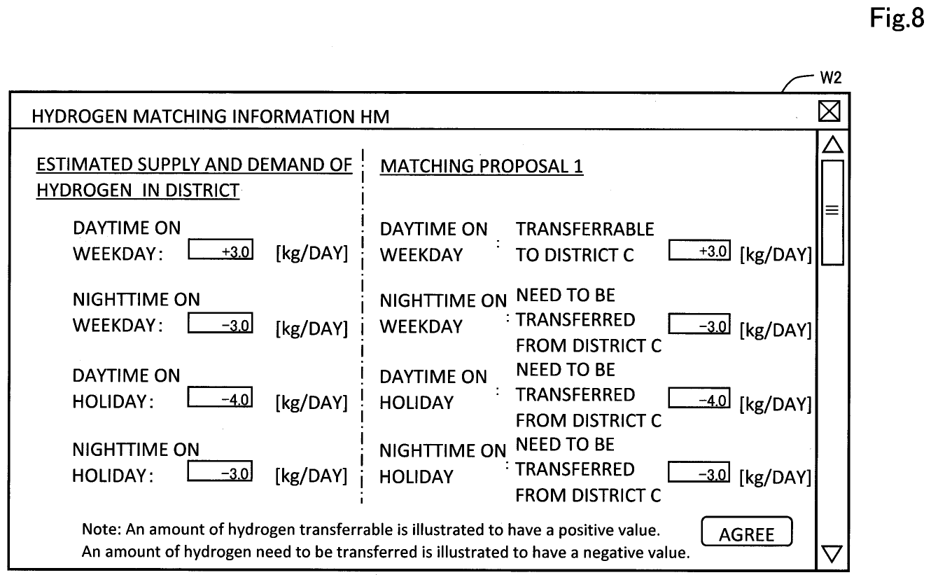

FIG. 8 is an explanatory diagram illustrating an example of a window W2 displaying the hydrogen matching information HM. In the example, the hydrogen matching information HM contains an estimation of supply and demand of hydrogen and a matching proposal in one of the hydrogen utilizing districts 100. An estimation of supply and demand of hydrogen reveals the state of supply and demand of hydrogen estimated in step S120 for each of the districts 100. A matching proposal proposes an amount of hydrogen exchangeable between the one of the districts 100 and at least another one of the districts 100. For example, the window W2 will be displayed on the district management device 120 in the one of the districts 100 in accordance with the hydrogen matching information HM received in step S140. When a supervisor managing the one of the districts 100 agrees with the matching proposal, the supervisor can press an “AGREE” button to proceed matching processing. A matching proposal to be displayed may contain a plurality of optional proposals. The hydrogen matching information HM to be displayed may take a form of a map to display a situation of supply and demand of hydrogen per each of the districts 100 or per time slot. Such a map described above can be used to visually easily know a state of supply and demand of hydrogen in each of the districts 100.

In step S150 in FIG. 6, the central management system 320 determines whether the two or more districts selected from among the districts 100 in step S130 have reached an agreement. If the two or more districts have not yet reached an agreement, the processing in FIG. 6 ends. When the two or more districts have reached an agreement, on the other hand, the processing proceeds to step S160. The central management system 320 urges the two or more of the districts 100 to conclude a contract on exchange of hydrogen.

As described above, the hydrogen supply and demand matching system proposes exchange of hydrogen in accordance with a state of supply and demand of hydrogen in each of the plurality of hydrogen utilizing districts 100. Matching of supply and demand of hydrogen among the plurality of hydrogen utilizing districts 100 can be thus obtained.

The present disclosure is not limited to the embodiments, the examples, and the modifications described above, and may be implemented in various ways without departing from the gist of the present disclosure. For example, the technical features of any of the above embodiments, examples, and modifications corresponding to the technical features of each of the aspects described in Summary may be replaced or combined appropriately, in order to solve part or all of the problems described above or in order to achieve part or all of the advantageous effects described above. Any of the technical features may be omitted appropriately unless the technical feature is described as essential in the description hereof. For example, the present disclosure may be implemented in the following aspects.

What is claimed is:

1. A hydrogen supply and demand matching system comprising:
a plurality of hydrogen utilizing districts each including a hydrogen utilizing facility; and
a management system configured to manage an amount of hydrogen in each of the plurality of hydrogen utilizing districts,
wherein the management system
(a) estimates a state of supply and demand of hydrogen in each of the plurality of hydrogen utilizing districts, and
(b) proposes exchange of hydrogen among the plurality of hydrogen utilizing districts in accordance with the state of supply and demand in each of the plurality of hydrogen utilizing districts.

2. The hydrogen supply and demand matching system according to claim 1,
wherein the management system
(b1) selects two or more hydrogen utilizing districts appropriate for exchange of hydrogen from among the plurality of hydrogen utilizing districts in accordance with the state of supply and demand in each of the plurality of hydrogen utilizing districts, and
(b2) sends hydrogen matching information proposing exchange of hydrogen between the two or more hydrogen utilizing districts to two or more management devices respectively configured to manage the two or more hydrogen utilizing districts.

3. A hydrogen supply and demand matching method used for management of an amount of hydrogen in each of a plurality of hydrogen utilizing districts each including a hydrogen utilizing facility, the hydrogen supply and demand matching method comprising:
estimating a state of supply and demand of hydrogen in each of the plurality of hydrogen utilizing districts; and
proposing exchange of hydrogen among the plurality of hydrogen utilizing districts in accordance with the state of supply and demand in each of the plurality of hydrogen utilizing districts.

4. The hydrogen supply and demand matching method according to claim 3, further comprising:
selecting two or more hydrogen utilizing districts appropriate for exchange of hydrogen from among the plurality of hydrogen utilizing districts in accordance with the state of supply and demand in each of the plurality of hydrogen utilizing districts; and
sending hydrogen matching information proposing exchange of hydrogen between the two or more hydrogen utilizing districts to two or more management devices respectively configured to manage the two or more hydrogen utilizing districts.
